(19) United States
(12) Patent Application Publication
(10) Pub. No.: US 2026/0359139 A1
(43) Pub. Date: Nov. 12, 2026

(54) DYNAMICALLY SCALING RESOURCES OF CONTAINER CLUSTERS TO ENABLE DEPLOYMENT OF APPLICATIONS

(71) Applicant: International Business Machines Corporation, Armonk, NY (US)

(72) Inventors: Xu LU, Xi'an (CN); Chong LIU, XIAN (CN); Jin XU, XIAN (CN); Qi MAO, Xi'an (CN); Chao LI, Xi'an (CN); A Long ZHI, XIAN (CN); Xiao KOU, Xi'an (CN)

(21) Appl. No.: 19/204,461

(22) Filed: May 9, 2025

(51) Int. Cl. G06F 9/50

(52) U.S. Cl. CPC G06F 9/5077; G06F 2209/503; G06F 2209/505

(57) ABSTRACT

A computer-implemented method, for scaling containers clusters, may comprise determining, using a machine learning model, different groups of container clusters for a plurality of container clusters, wherein the different groups of container clusters identify different levels of resource usage; determining a particular group of container clusters with a lowest level of resource usage of the different levels of resource usage; predicting, using a time series model, resource usage of a container cluster of the particular group of container clusters, the time series model being constructed based on historical resource usage of the container cluster; and adjusting a number of resources, of the container cluster, to deploy an application on the platform.

### BACKGROUND

The present invention relates to container clusters, and for example, relates to dynamically scaling resources of a container cluster to enable deployment of an application.

A container cluster includes nodes (e.g., machines) that are connected and that work as a single unit to run and manage containerized applications. For example, the nodes run containers. A container is an executable unit of software that package application code along with its libraries and dependencies. A container cluster may use of container orchestration tools to manage nodes and containers.

### SUMMARY

A computer-implemented method for scaling containers of clusters of containers, the computer-implemented method comprising: determining different groups of container clusters from a plurality of container clusters of a platform, wherein the different groups of container clusters are determined based on information regarding resource usage of the plurality of container clusters and operation behavior of the plurality of container clusters, and wherein the different groups of container clusters are associated with different levels of resource usage; determining a particular group of container clusters with a lowest level of resource usage of the different levels of resource usage; constructing a time series model to predict resource usage of a container cluster of the particular group of container clusters, the time series model being constructed based on historical resource usage of the container cluster; determining whether available resources, of the platform, are sufficient to deploy an application; releasing one or more resources, of the container cluster, when the available resources are insufficient to deploy the application; and adding the one or more resources to the available resources to attempt to deploy the application.

A computer program product comprising: one or more computer-readable storage media; and program instructions stored on the one or more computer readable storage media to perform operations comprising: determining, using a machine learning model, different groups of container clusters for a plurality of container clusters of a platform, wherein the different groups of container clusters are associated with different levels of resource usage; determining a particular group of container clusters with a lowest level of resource usage of the different levels of resource usage; predicting, using a time series model, predicted resource usage of a container cluster of the particular group of container clusters, the time series model being generated based on historical resource usage of the container cluster; determining whether available resources, of the platform, are sufficient to deploy an application; releasing one or more resources, of the container cluster, when the available resources are insufficient to deploy the application; and adding the one or more resources to the available resources to deploy the application.

A computer-implemented method, for scaling containers clusters, may comprise determining, using a machine learning model, different groups of container clusters for a plurality of container clusters, wherein the different groups of container clusters identify different levels of resource usage; determining a particular group of container clusters with a lowest level of resource usage of the different levels of resource usage; predicting, using a time series model, resource usage of a container cluster of the particular group of container clusters, the time series model being constructed based on historical resource usage of the container cluster; and adjusting a number of resources, of the container cluster, to deploy an application on the platform.

### BRIEF DESCRIPTION OF THE DRAWINGS

FIG. 1 illustrates a block diagram of a computing environment described herein.

FIG. 2 is a diagram of an example implementation described herein.

FIG. 3 is a diagram of an example computing environment in which systems and/or methods described herein may be implemented.

FIGS. 4 and 5 are flowcharts of an example process associated with dynamically scaling resources of container clusters.

FIG. 6 is a diagram of example components of one or more devices of FIGS. 1 and 2.

FIG. 7 is a flowchart of an example process associated with dynamically scaling resources of container clusters.

### DETAILED DESCRIPTION

The following detailed description of example implementations refers to the accompanying drawings. The same reference numbers in different drawings may identify the same or similar elements.

In some examples, an infrastructure may be allocated to set up (or deploy) a container cluster on an infrastructure platform. The container cluster may include nodes. A group of users (e.g., an organization) may be allocated a quota for resources. A “resource” may be used herein to refer to a node (e.g., a worker node, a computing device). Typically, once the quota is used up, resources of the container cluster are not released. Because the resources are not released and the quota is used, users (of the group of users) are unable to create new container clusters or expand the capacity of existing container clusters.

As an example, the container cluster may be deployed for the purpose of performing of testing (e.g., testing an application). In some situations, a significant number of resources may be allocated for the container cluster. In other words, the container cluster may be configured to utilize a significant number of resources. After the testing is completed, the container cluster may be underutilized or not utilized at all. For example, the resources (allocated to the container cluster) may be underutilized or may not be used at all.

While the resources may be underutilized or not used, the resources are not released. In other words, the resources are not deallocated from the container cluster. In this regard, if an attempt is made to deploy a new container cluster on the infrastructure platform, the attempt will be unsuccessful because the infrastructure platform may not have a sufficient number of resources to deploy the new container cluster. Similarly, if an attempt is made to increase resources of an existing container cluster, the attempt will be unsuccessful because the infrastructure platform may not have a sufficient number of resources to increase the resources.

Based on the foregoing, existing platforms are subject to a technical problem of underutilized container clusters utilizing resources in a manner that prevents deployment of additional container clusters or that prevents expanding resources of existing container clusters. In other words, because the container clusters are underutilized or not utilized at all, the container clusters are wasting computational capabilities of the resources of such container clusters. Accordingly, a need exists to address the technical problem described above.

Implementations described herein are directed to dynamically adjusting a configuration of a container cluster that is underutilized and automatically scaling down resources of the container cluster to improve the efficiency of resource usage of a platform. In some examples, the platform may include an infrastructure platform. By scaling down the resources of the container cluster, the platform may be able to better meet the needs of a user with respect to deploying a new container cluster or with respect to expanding the resources of an existing container cluster.

Implementations described herein are directed to an analytic engine that may use a cluster model to determine different groups (or categories) of container clusters based on the current resource usage of the container clusters. Each group (or category) may be associated with a different level of resource usage. For example, a first group may be associated with a first level of resource usage (e.g. low level), a second group may be associated with a second level of resource usage (e.g. medium level), a third group may be associated with a third level of resource usage (e.g. low level), and so on. As used herein, a “resource usage” may refer to a number of resources (e.g., included in, or in other words, utilized by a container cluster). A “resource” may refer to a node, such as a worker node, a machine, a computing device, among other examples.

In some examples, the analytic engine may construct a time series model to perform a time series operation on container clusters in the group with the least amount of resource usage (e.g., the lowest amount of resource usage) and operation to predict resource usage for the container cluster over a period in the future (e.g., a future period of time). In some examples, the analytic engine may identify a container cluster (from the group) with a largest difference between the predicted resource usage and a current resource usage. For instance, the analytic engine may identify the container cluster that include one or more resources that may most likely be released to enable a new container cluster to be deployed and/or to enable an existing container cluster to expand resources utilized.

Beginning with the container cluster with the largest difference between the predicted resource usage and the current resource usage, the container cluster may be scaled down the container cluster to release one or more resources from the container cluster. The one or more resources may be added to available resources of the platform. When the available resources meet resource requirements for a container cluster in a cluster application queue, an execution engine may create a new container cluster or may expand a container cluster to deploy an application.

As described herein, implementations described herein are directed to a technical solution that includes grouping (or clustering) container clusters, of a platform, based on resource usage. The technical solution further includes generating (or constructing) a time series model to predict resource usage of a group of container clusters with a lowest level of resource usage. The technical solution further includes continuously and automatically adjusting a number of container clusters and scaling up/down the container clusters according to user needs on the platform. In some implementations, the container clusters may be scaled up/down on a node level instead of on the pod level.

In this regard, the technical solution may be used to determine container clusters that are underutilized. Additionally, or alternatively, the technical solution may be used to maximize an efficiency of resource usage in the platform. Additionally, or alternatively, the technical solution is to avoid making cluster fragmentation in the platform.

One advantage of the technical solution described herein is improving resource utilization of a platform (e.g., an infrastructure platform). Another advantage of the technical solution is responding more effectively to user needs and improving user satisfaction and productivity involving the platform. Yet another advantage of the technical solution is saving costs for an enterprise.

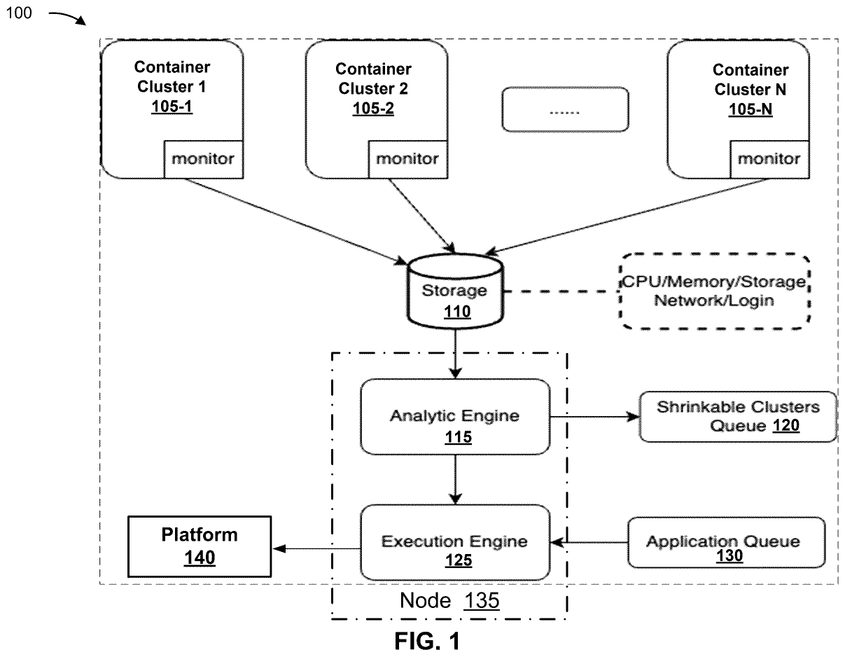

FIG. 1 illustrates a block diagram of a computing environment 100 for scaling resources of container clusters. The computing environment 100 includes a first container cluster 105-1, a second container cluster 105-2, and so on up to an nth container cluster 105-N (collectively “container clusters 105” and individually “container cluster 105”), a storage 110, an analytic engine 115, a shrinkable clusters queue 120 (also referred to as “clusters queue 120”), an execution engine 125, an application queue 130, a node 135, and a platform 140. In some implementations, the node 135 may include the storage 110, the analytic engine 115, the clusters queue 120, the execution engine 125, and/or the application queue 130. In some implementations, the analytic engine 115 may include the clusters queue 120. In some implementations, the execution engine 125 may include the application queue 130. In some implementations, the container clusters 105, the storage 110, the storage 110, the analytic engine 115, the execution engine 125, and/or the application queue 130 may be connected via a network.

A container cluster 105 may include multiple resources (e.g., multiple nodes) that are connected and that work as a single unit to run and manage containerized applications. For example, the nodes may run containers. In some examples, the container cluster 105 may be deployed for the purpose of performing of testing (e.g., testing an application). In this regard, a service-level agreement (SLA) may not exist for a platform that manages the container cluster 105.

As shown in FIG. 1, the container cluster 105 may include a monitoring component that monitors different attributes of resources of the container cluster 105. For example, the monitoring component may monitor central processing unit (CPU) usage of the resources, memory usage of the resources, storage usage of the resources, and/or network usage of the resources. Additionally, or alternatively, the monitoring component may monitor a frequency of user login, a frequency of operation of the resource, among other examples. The operation may include changing a configuration of the application, modifying a specification for deployment, among other examples. The monitoring component may generate resource information that may include CPU usage of the resource, memory usage of the resource, storage usage of the resource, and/or network usage of the resource. Additionally, or alternatively, the monitoring component may generate frequency information that may include a frequency of user login, a frequency of operation of the resource, among other examples. The frequency information may be included in an operation behavior of the container cluster 105. The monitoring component may provide the resource information and the frequency information to the storage 110 for storage. In some examples, the frequency information may identify task priorities associated with one or more container clusters 105. For example, a task priority may identify a priority of task to be performed by the one or more container clusters 105.

A resource or node (of a container cluster 105) may include a computing device. The computing device may encompass a wide range of computing systems and architectures. In some aspects, the computing device may be part of a cloud computing infrastructure, which may include public, private, or hybrid cloud environments. Cloud computing devices may include virtualized resources, such as virtual machines or containers, running on physical hardware in data centers. In some implementations, the computing device may be based on mainframe architectures. These systems may be designed for high-volume transaction processing and may include features like redundant components for high availability and reliability.

The computing device may include a distributed system, such as those based on microservices architectures. In these systems, applications may be broken down into smaller, independent services that communicate over a network. In some implementations, the computing device may be an edge computing node, which process data closer to the source of data generation. In some implementations, the computing device may include a computer, a mobile device, such as smartphones or tablet, among other examples. The computer device may be operated by a user. In some examples, the computer device may be executing an application and, as a result, a user interface may be presented on a display of the computer device 105. The user may use the computing device to navigate different portions of the application (e.g., different locations).

The storage 110 may store the resource information and the frequency information for different container cluster 145. The storage 110 may include a data store, a combination of relational databases, NoSQL databases, and file systems to efficiently organize and retrieve different data structures.

The analytic engine 115 may include one or more components that identify groups of container clusters and that forecast or predicts resource usage of one or more groups of container clusters. For example, the analytic engine 115 may group (or cluster) container clusters, of a platform, based on resource usage of the container clusters. Additionally, or alternatively, the analytic engine 115 may generate (or construct) a time series model to predict resource usage of one or more groups of container clusters (e.g., a group of container clusters with a lowest level of resource usage). In some implementations, the analytic engine 115 may include information regarding the one or more groups of container clusters in a queue (e.g., a clusters queue 120). In some implementations, the analytic engine 115 may include a machine learning model that determines groups or clusters (e.g., a cluster model).

The clusters queue 120 may include a queue that stores information regarding one or more groups of container clusters. In some implementations, a resource usage of the one or more groups of container clusters may be less than a resource usage of other groups of container clusters. The information regarding a group of container clusters may include information identifying each container cluster, information identifying a resource usage of each container cluster, information identifying one or more resources (of each container cluster) that may be scaled, among other examples.

The execution engine 125 may include one or more components that continuously and automatically adjusts a number of container clusters and scaling up/down the container clusters according to user needs on the platform. For example, the execution engine 125 may select an application to be deployed and determine whether available resources of the platform are sufficient to deploy the application. If the execution engine 125 determines that the available resources are not sufficient, the execution engine 125 may scale down a container cluster to release one or more resources of the container cluster. The one or more resources may be added to the available resources to deploy the application (or at least to attempt to deploy the application). The execution engine may deploy the application if the available resources are sufficient.

The application queue 130 may include a queue that stores information regarding applications to be deployed via the platform. In some implementations, information regarding an application may identify computational requirements for the application, network requirements for the application, storage requirements for the application, among other examples.

The node 135 may include a computing device as described herein. The platform 140 may include a system that orchestrates and manages containerized applications across a group of nodes. The platform 140 may manage containerized applications, handling lifecycle, deployment, and scaling within a cluster of nodes.

As indicated above, FIG. 1 is provided as an example. Other examples may differ from what is described with regard to FIG. 1. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

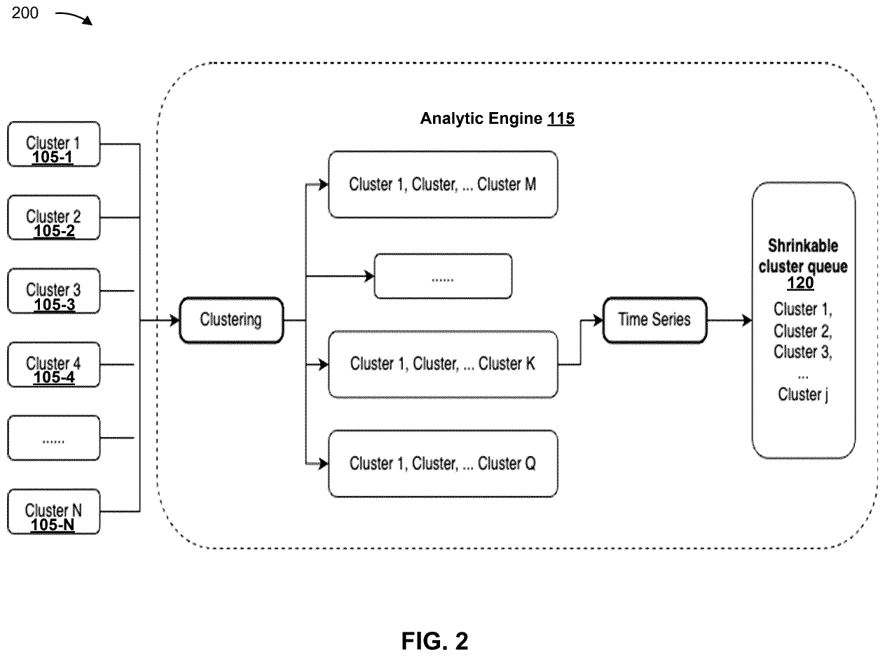

FIG. 2 is a diagram of an example implementation 200 described herein. As shown in FIG. 2, example implementation 200 includes container clusters 105, the analytic engine 115, and the clusters queue 120. As shown in FIG. 2, the analytic engine 115 may include the clusters queue 120. As shown in FIG. 2, the analytic engine 115 may perform a clustering operation on the container clusters 105 to identify different clusters of container clusters 105 (e.g., different groups of container clusters 105). Each group may be associated with different resource usage. In some implementations, the analytic engine 115 may perform the clustering operation using a machine learning model (e.g., a cluster model). As shown in FIG. 2, the analytic engine 115 may identify different groups of container cluster 105 that include one or more container clusters 105.

As shown in FIG. 2, the analytic engine 115 may select a group of container clusters and perform a time series operation on the group of container clusters. In some implementations, the selected group of container clusters may be a container cluster associated with a lowest resource usage. As shown in FIG. 2, the analytic engine 115 may perform the time series operation to forecast resource usage of the container cluster.

As indicated above, FIG. 2 is provided as an example. Other examples may differ from what is described with regard to FIG. 2. There may be additional devices (e.g., a large number of devices), fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices in FIG. 2.

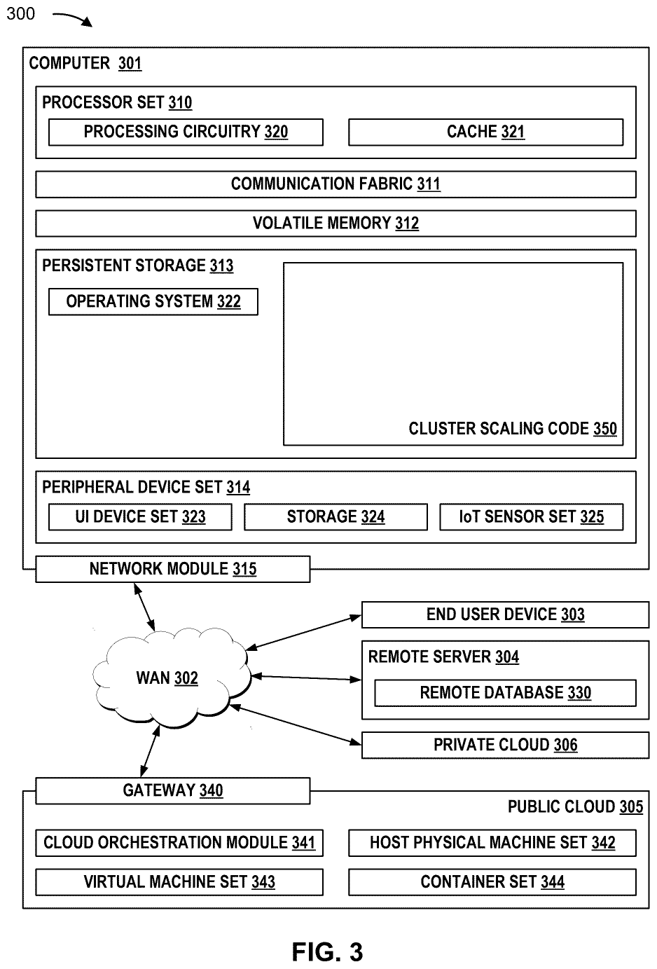

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as a cluster scaling code, shown in block 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

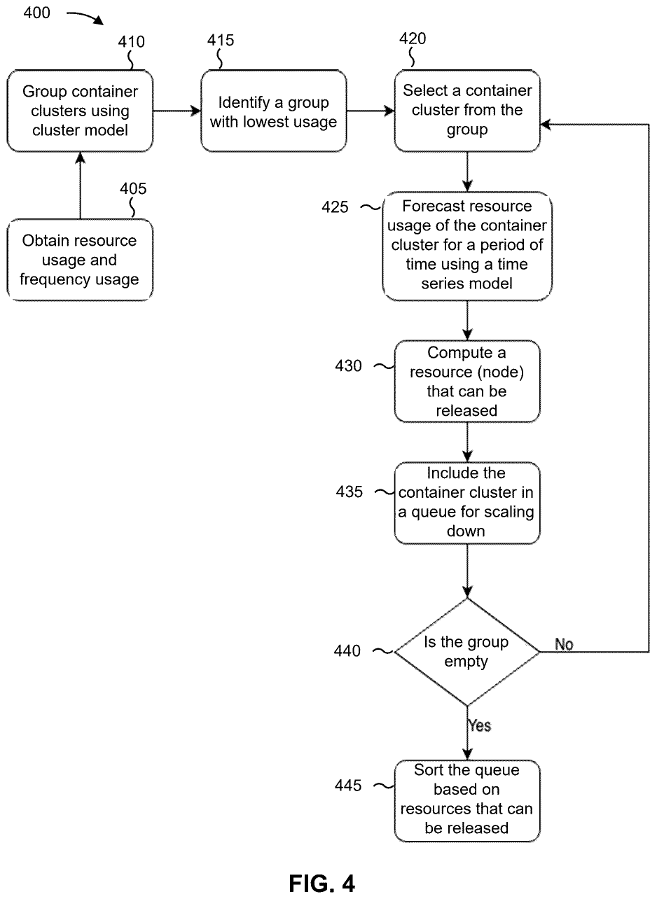

FIG. 4 is a flowchart of an example process 400 associated with scaling resources of container clusters. In some implementations, one or more process blocks of FIG. 4 may be performed by an analytic engine (e.g., the analytic engine 115) and/or an execution engine (e.g., the execution engine). Additionally, or alternatively, one or more process blocks of FIG. 4 may be performed by one or more components of device 600, such as processor 620, memory 630, storage component 640, input component 650, output component 660, and/or communication component 670.

As shown in FIG. 4, process 400 may include obtaining resource usage and frequency usage (block 405). For example, the analytic engine 115 may obtain resource information regarding resource usage and frequency information regarding frequency usage of container clusters of a platform. In some examples, the analytics engine may obtain the resource information and the frequency information from a storage element, such as the storage 110.

In some examples, the resource information may include CPU usage of the resource, memory usage of the resource, storage usage of the resource, and/or network usage of the resource. The CPU usage, the memory usage, the storage usage, and/or the network usage may be referred to as resource attributes. The frequency information may include a frequency of user login, a frequency of operation of the resource, among other examples. The operation may include changing a configuration of the application, modifying a specification for deployment, among other examples. The frequency of user login and the frequency of operation may be referred to as frequency attributes. The frequency attributes may include an operation behavior of a container cluster.

As shown in FIG. 4, process 400 may include grouping container clusters using cluster model (block 410). For example, the analytic engine 115 may determine different groups of container clusters based on the resource information and the frequency information of container clusters. In some examples, the analytic engine 115 may determine a first group of container clusters with a first level of resource usage, a second group of container clusters with a second level of resource usage, and so on.

In some examples, the analytic engine 115 may determine the different groups of container clusters using a machine learning model. The machine learning model may include a cluster model. For example, the machine learning model may include a K-Means clustering machine learning algorithm, a density-based spatial clustering of applications with noise (DBSCAN) machine learning algorithm, among other cluster models.

In some implementations, the analytic engine 115 may build the machine learning model using historical resource information and historical frequency information. For example, the analytic engine 115 may train the machine learning model using the historical resource information and the historical frequency information.

As shown in FIG. 4, process 400 may include identifying a group with lowest usage (block 415). For example, the analytic engine 115 may identify a group of container clusters with a lowest resource usage out of the groups of container clusters identified by the analytic engine.

As shown in FIG. 4, process 400 may include selecting a container cluster from the group (block 420). For example, the analytic engine 115 may select a container cluster from the group with the lowest resource usage.

As shown in FIG. 4, process 400 may include forecasting resource usage of the container cluster for a period of time using a time series model (block 425). For example, the analytic engine 115 may forecast a predicted resource usage of the container cluster for a future period of time (e.g., for a window size of the time series). For instance, the analytic engine 115 may forecast a quantity of resources (of the container cluster) that may be used during the period of time and/or may forecast specific resources that may be used during the period of time. In some examples, the window size may be configurable. In some situations, a user associated with the analytic engine 115 may select the window size (e.g., twenty four hours, forty eight hours, among other examples).

In some situations, the analytic engine 115 may select the window size (e.g., based on previous periods of time used by the time series model). In some examples, the analytic engine 115 may adjust the window size of the time series based on an accuracy of the predicted resource usage predicted by the time series model. For example, if the analytic engine predicts that resources of the container cluster will not be used within forty eight hours, and the resources are requested within 24 hours, then the analytic engine 115 may reduce the window size to 24 hours or less. For instance, the analytic engine 115 may determine that an accuracy of the predicted resource usage does not satisfy an accuracy threshold and may adjusting the window size of the time series based on determining that the accuracy of the predicted resource usage does not satisfy the accuracy threshold.

The analytic engine 115 may forecast the resource usage based on historical resource usage of the container cluster. Information regarding the historical resource usage of the container cluster may be obtained from storage 110. The information regarding the historical resource usage may be provided as an input to a time series model. The time series model may predict the resource usage of the container cluster for the period of time. In some examples, the information regarding the historical resource usage may identify one or more nodes of the container cluster and a frequency of usage of the one or more nodes. In this regard, the time series model may predict the usage of the one or more nodes of the container cluster. In some examples, the time series model may include an autoregressive integrated moving average (ARIMA) model, a seasonal ARIM (SARIMA) model, an autoregressive moving average (ARMA) model, among other examples. In some examples, the analytic engine 115 may build the time series model.

As shown in FIG. 4, process 400 may include compute a resource (node) that can be released (block 430). For example, the analytic engine 115 may determine a resource (or node), of the container cluster, that can be released. In some implementations, the analytic engine 115 may compare a predicted resource usage (or future resource usage) of the resources and a current resource usage of the resources to identify the resource that can be released. For example, the analytic engine 115 may identify a resource that is not predicted to be used within the window size and determine whether the resource is currently being used. If the resource is not currently being used, the analytic engine 115 may identify the resource as a resource that can be released. By comparing the predicted resource usage and the current resource usage, the analytic engine 115 may determine an availability of the resource.

In some implementations, the analytic engine 115 may determine one or more resources that are forecasted to be less frequently used out of all the resources of the container cluster (e.g., one or more resources are forecasted to not be used within the window size). In some implementations, the analytic engine 115 may rank the resources (of the container cluster) from forecasted to be least frequently used to most frequently used. In this regard, the analytic engine 115 may select a resource, from the ranked resources, to be released based on the ranking (e.g., from forecasted least frequently used to most frequently).

As shown in FIG. 4, process 400 may include including the container cluster in a queue for scaling down (block 435). For example, the analytic engine 115 may include the container cluster in the clusters queue 120. In some examples, the analytic engine 115 may generate the clusters queue 120. The clusters queue 120 may store information regarding one or more container clusters that may be scaled down. As used herein, a container cluster may be scaled down by releasing one or more resources. In other words, the one or more resources may be deallocated from the container cluster.

In some implementations, the analytic engine 115 may include the container cluster in the clusters queue 120 if the container cluster includes a number threshold of resources that are not forecasted to be used within the time window and that are not currently being used. In some implementations, the analytic engine 115 may include the container cluster in the clusters queue 120 if the container cluster includes a number threshold of resources that do not satisfy a forecasted usage frequency threshold. As an example, the analytic engine 115 may include the container cluster in the clusters queue 120 if half or more of the resources are not forecasted to be used within the window size. The number threshold and/or the forecasted usage frequency threshold may be selected by a user associated with the analytic engine 115 (e.g., an administrator of the analytic engine 115).

In some implementations, the clusters queue 120 may identify a minimal cluster capacity of the container cluster. As used herein, a “minimal cluster capacity” may refer to a minimum number of resources (nodes) that may be used by (or, in other words, included in) the container cluster for the cluster to be operation. In some examples, the minimal cluster capacity may be determined by a user associated with the container cluster (e.g., an administrator). In some examples, the minimal cluster capacity may be determined by the execution engine 125 based on information regarding an application that is to be supported by the container cluster. The information regarding the application may identify computational requirements for the application, network requirements for the application, storage requirements for the application, among other examples. The minimal cluster capacity may vary from one container cluster to another container cluster.

As shown in FIG. 4, process 400 may include determining if the group is empty (block 440). For example, after the container cluster to the clusters queue 120, the analytic engine 115 may determine whether the group with the lowest usage includes additional container clusters. If the group includes additional container clusters, the analytic engine 115 may select another container cluster from the group in a manner similar to the manner described above in connection with reference number 420 and perform the actions described in connections with reference numbers 425 to 440.

As shown in FIG. 4, process 400 may include sorting the queue based on the resources that can be released (block 445). For example, if the analytic engine 115 determines that the group does not include any additional container clusters after the container cluster is included in the clusters queue 120, the analytic engine 115 may sort the clusters queue 120. The clusters queue 120 may store an identifier or a name of the container clusters that can release resources. The container clusters may be based sorted based on a number of resources that can be released by the containers. For example, a container cluster that can release more resources out of all the container clusters may be ranked higher than other container clusters. Such container cluster may be selected first, and one or more resources of the container cluster may be released when a new application is to be deployed or when an existing container cluster is to be expanded (e.g., by adding one or more additional resources to the existing container cluster. In some implementations, the analytic engine 115 may sort the clusters queue 120 based on the availability of the resources. In some implementations, the analytic engine 115 may sort the clusters queue 120 from a cluster container with a highest number of resources that can be released to a cluster container with a lowest number of resources that can be released. In some implementations, the analytic engine 115 may sort the clusters queue 120 from a cluster container with a highest number of resources to be least frequently used to a cluster container with a lowest number of resources to be least frequently used.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

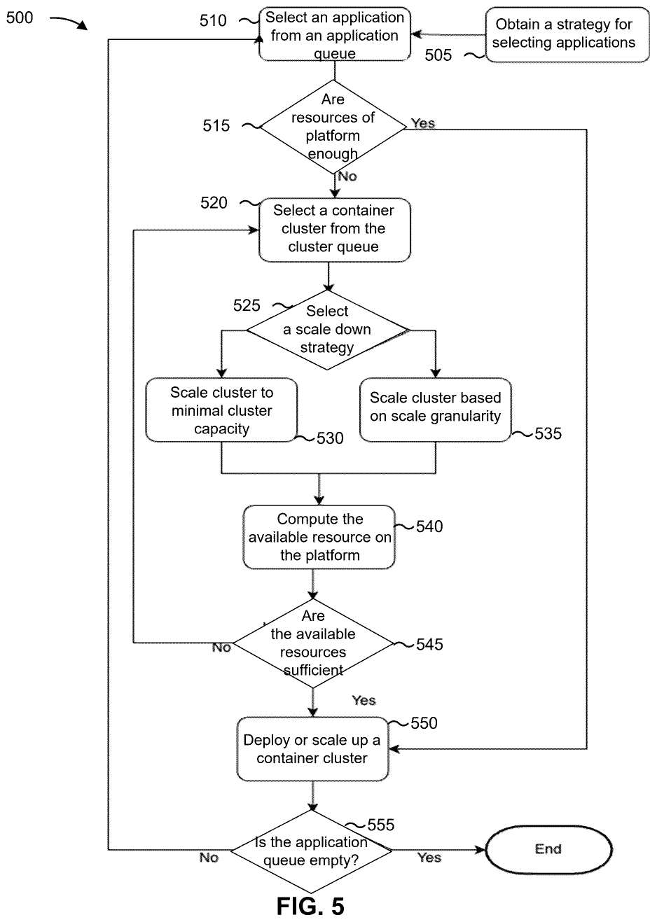

FIG. 5 is a flowchart of an example process 500 associated with scaling resources of container clusters. In some implementations, one or more process blocks of FIG. 5 may be performed by an analytic engine (e.g., the analytic engine 115) and/or an execution engine (e.g., the execution engine). Additionally, or alternatively, one or more process blocks of FIG. 5 may be performed by one or more components of device 600, such as processor 620, memory 630, storage component 640, input component 650, output component 660, and/or communication component 670.

As shown in FIG. 5, process 500 may include obtaining a strategy for selecting applications (block 505). For example, the execution engine 125 may obtain the strategy (for selecting applications) from a memory associated with the execution engine 125. The execution engine 125 may select the applications from an application queue. In some implementations, the strategy may include selecting the applications from the application queue based on a first in first out algorithm. For example, the strategy may include selecting the applications from the application queue based on an order of receiving a request for deploying an application. In some implementations, the strategy may include selecting the applications from the application queue based on a minimum demand. For example, the strategy may select an application that needs a least number of resources.

As shown in FIG. 5, process 500 may include selecting an application from an application queue (block 510). For example, the execution engine 125 may select an application from the application queue using the strategy.

As shown in FIG. 5, process 500 may include determining whether resources a platform are sufficient (block 515). For example, after selecting the application, the execution engine 125 may determine whether available resources, of the platform, are sufficient to deploy the application. The “available resources,” may be used herein to refer to resources that are not being used.

As shown in FIG. 5, process 500 may include selecting a container cluster from the cluster queue (block 520). For example, based on determining that the available resources are insufficient to deploy the application, the execution engine 125 may select a container cluster from the clusters queue 120.

As shown in FIG. 5, process 500 may include selecting a scale down strategy (block 525). For example, after selecting the container cluster, the execution engine 125 may select a strategy for scaling down resources of the container cluster. The resources to be released may include resource that are currently available (or, in other words, unused) and that have been forecasted to be available within the window size. In some examples, the execution engine 125 may select the strategy based on input from a user associated with the execution engine 125. In other words, the user may select the strategy. In some examples, the execution engine 125 may select the strategy based on historical information regarding different strategies that were selected based on different applications, different availability of resources on the platform, different times of day, different types of resources, among other examples.

As shown in FIG. 5, process 500 may include scaling the cluster to a minimal cluster capacity (block 530). For example, the execution engine 125 may select a strategy to scale the container cluster to a minimal cluster capacity as the strategy for scaling down resources of the container cluster. The execution engine 125 may release one or more resources based on the minimal cluster capacity of the container cluster. For instance, the execution engine 125 may determine the minimal cluster capacity of the container cluster based on the information identifying the minimal cluster capacity stored in the clusters queue 120. Based on determining the minimal cluster capacity, the execution engine 125 may scale down (or reduce) the container cluster to the minimal cluster capacity. For example, the execution engine 125 may deallocated or remove a number of resources from the container cluster until the minimum number of resources.

As shown in FIG. 5, process 500 may include scaling the cluster based on scale granularity (block 535). For example, the execution engine 125 may select a strategy to scale the container cluster based on a scale granularity. By scaling the container cluster based on the scale granularity, the execution engine 125 may determine a resource (or a node) to be released. In other words, the scale granularity strategy may identify one or more resources that may be released. For example, the scale granularity strategy may include a setting regarding a quantity of resources to be released per cycle (or, in other words, per iteration of process 500).

As shown in FIG. 5, process 500 may include computing the available resource on the platform (block 540). For example, after scaling down the container cluster, the execution engine 125 may determine the resources currently available on the platform. The execution engine 125 may add the one or more resources (that have been deallocated or released from the container cluster) to the available resources to attempt to deploy the application. The resources currently available on the platform may include the one or more resources that have been deallocated or released from the container cluster.

As shown in FIG. 5, process 500 may include determining whether the available resources are sufficient (block 545). For example, the execution engine 125 may determine whether the resources currently available are sufficient to deploy the application. In some implementations, if the execution engine 125 determines that the resources currently available are not sufficient to deploy the application, the execution engine 125 may select an additional container cluster to scale down if the strategy selected was the minimal cluster capacity. The execution engine 125 may select a scale down strategy and scale down the additional container cluster as described herein.

In some implementations, if the execution engine 125 determines that the resources currently available are not sufficient to deploy the application, the execution engine 125 may further scale down the container cluster if the scale granularity strategy was selected. In this regard, the execution engine 125 may release (e.g., deallocate or remove) one or more additional resources from the container cluster. The execution engine 125 may perform this action multiple times until the container cluster is scaled down to the minimal cluster capacity of the container cluster.

As shown in FIG. 5, process 500 may include deploying or scaling up a container cluster (block 550). For example, the execution engine 125 may determine that the resources currently available are sufficient to deploy the application. In some implementations, if the execution engine 125 determines that the resources currently available are sufficient to deploy the application, the execution engine 125 may deploy a new container cluster to deploy the application or may scale up an existing container cluster to deploy the application. In some examples, when scaling up the existing container cluster, the execution engine 125 may allocate or add the one or more resources that were released to the existing container cluster.

In some examples, after selecting the application, if the execution engine 125 determine that the available resources are sufficient to deploy the application, the execution engine 125 may deploy a new container cluster to deploy the application or may scale up an existing container cluster to deploy the application, as explained herein.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As shown in FIG. 5, process 500 may include determining whether the application queue (block 510). For example, after deploying the new container cluster or scaling up the new container cluster to deploy the application, the execution engine 125 may determine the application queue is empty. If the application queue is empty, process 500 may end. Alternatively, if the application queue is not empty, the execution engine 125 may select a next application from the application queue using the strategy, in a manner similar to the manner described herein. The execution engine 125 may deploy the next application in a manner similar to the manner described herein.

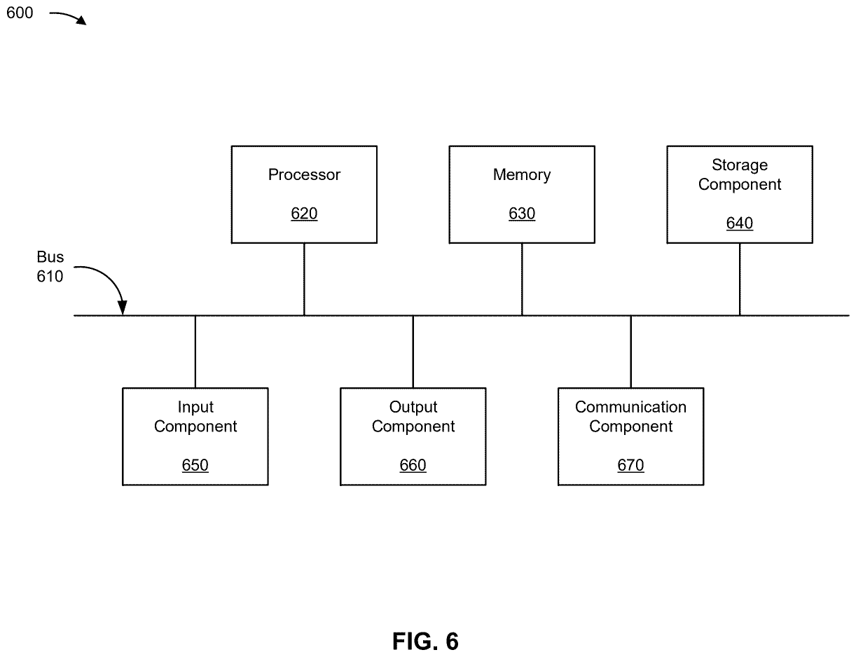

FIG. 6 is a diagram of example components of a device 600, which may implement one or more components of the computing environment 100. As shown in FIG. 6, device 600 may include a bus 610, a processor 620, a memory 630, a storage component 640, an input component 650, an output component 660, and a communication component 670.

Bus 610 includes a component that enables wired and/or wireless communication among the components of device 600. Processor 620 includes a central processing unit, a graphics processing unit, a microprocessor, a controller, a microcontroller, a digital signal processor, a field-programmable gate array, an application-specific integrated circuit, and/or another type of processing component. Processor 620 is implemented in hardware, firmware, or a combination of hardware and software. In some implementations, processor 620 includes one or more processors capable of being programmed to perform a function. Memory 630 includes a random access memory, a read only memory, and/or another type of memory (e.g., a flash memory, a magnetic memory, and/or an optical memory).

Storage component 640 stores information and/or software related to the operation of device 600. For example, storage component 640 may include a hard disk drive, a magnetic disk drive, an optical disk drive, a solid state disk drive, a compact disc, a digital versatile disc, and/or another type of non-transitory computer-readable medium. Input component 650 enables device 600 to receive input, such as user input and/or sensed inputs. For example, input component 650 may include a touch screen, a keyboard, a keypad, a mouse, a button, a microphone, a switch, a sensor, a global positioning system component, an accelerometer, a gyroscope, and/or an actuator. Output component 660 enables device 600 to provide output, such as via a display, a speaker, and/or one or more light-emitting diodes. Communication component 670 enables device 600 to communicate with other devices, such as via a wired connection and/or a wireless connection. For example, communication component 670 may include a receiver, a transmitter, a transceiver, a modem, a network interface card, and/or an antenna.

Device 600 may perform one or more processes described herein. For example, a non-transitory computer-readable medium (e.g., memory 630 and/or storage component 640) may store a set of instructions (e.g., one or more instructions, code, software code, and/or program code) for execution by processor 620. Processor 620 may execute the set of instructions to perform one or more processes described herein. In some implementations, execution of the set of instructions, by one or more processors 620, causes the one or more processors 620 and/or the device 600 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 6 are provided as an example. Device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

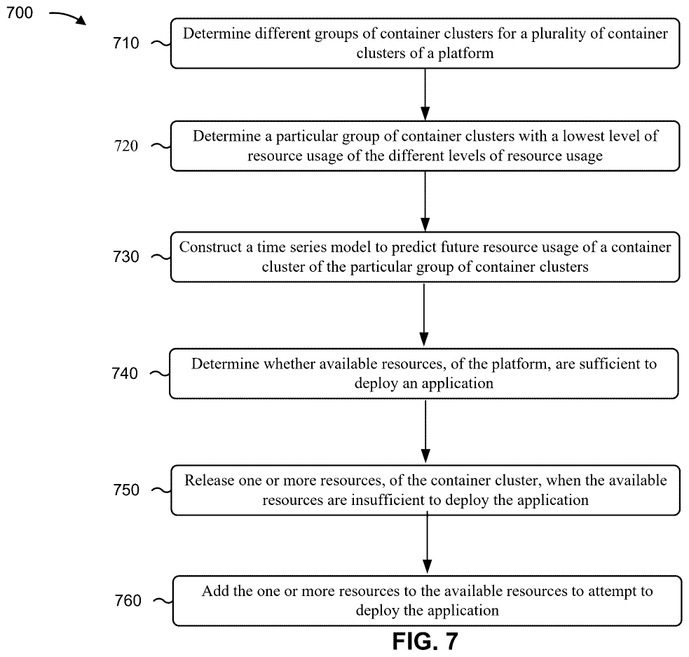

FIG. 7 is a flowchart of an example process 700 associated with scaling resources of container clusters. In some implementations, one or more process blocks of FIG. 7 may be performed by an analytic engine (e.g., the analytic engine 115) and an execution engine (e.g., the execution engine). Additionally, or alternatively, one or more process blocks of FIG. 7 may be performed by one or more components of device 600, such as processor 620, memory 630, storage component 640, input component 650, output component 660, and/or communication component 670.

As shown in FIG. 7, process 700 may include determining different groups of container clusters for a plurality of container clusters of a platform (block 710). For example, the analytic engine 115 may determine different groups of container clusters for a plurality of container clusters of a platform.

As shown in FIG. 7, process 700 may include determining a particular group of container clusters with a lowest level of resource usage of the different levels of resource usage (block 720). For example, the analytic engine 115 may determine a particular group of container clusters with a lowest level of resource usage of the different levels of resource usage.

As shown in FIG. 7, process 700 may include constructing a time series model to predict resource usage of a container cluster of the particular group of container clusters (block 730). For example, the analytic engine 115 may construct a time series model to predict resource usage of a container cluster of the particular group of container clusters.

As shown in FIG. 7, process 700 may include determining whether available resources, of the platform, are sufficient to deploy an application (block 740). For example, the executing engine may determine whether available resources, of the platform, are sufficient to deploy an application.

As shown in FIG. 7, process 700 may include releasing one or more resources, of the container cluster, when the available resources are insufficient to deploy the application (block 750). For example, the execution engine may release one or more resources, of the container cluster, when the available resources are insufficient to deploy the application.

As shown in FIG. 7, process 700 may include adding the one or more resources to the available resources to attempt to deploy the application (block 760). For example, the execution engine may add the one or more resources to the available resources to attempt to deploy the application.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method for scaling containers clusters, the computer-implemented method comprising:
determining different groups of container clusters from a plurality of container clusters of a platform, wherein the different groups of container clusters are determined based on information regarding resource usage of the plurality of container clusters and operation behavior of the plurality of container clusters, and wherein the different groups of container clusters are associated with different levels of resource usage;
determining a particular group of container clusters with a lowest level of resource usage of the different levels of resource usage;
constructing a time series model to predict resource usage of a container cluster of the particular group of container clusters, the time series model being constructed based on historical resource usage of the container cluster;
determining whether available resources, of the platform, are sufficient to deploy an application;
releasing one or more resources, of the container cluster, when the available resources are insufficient to deploy the application; and
adding the one or more resources to the available resources to attempt to deploy the application.

2. The computer-implemented method of claim 1, wherein determining the different groups of container clusters comprises:
determining the different groups of container clusters using a machine learning model.

3. The computer-implemented method of claim 1, further comprising:
predicting, using the time series model, resource usage of container clusters of the particular group of container clusters;
determining a current resource usage of the container clusters;
determining availability of resources of the container clusters based on the future resource usage and the current resource usage; and
sorting the container clusters based on the availability of resources of the container clusters.

4. The computer-implemented method of claim 1, further comprising:
determining a number of the one or more resources based on the available resources and the predicted resource usage.

5. The computer-implemented method of claim 1, further comprising:
adjusting a window size of the time series based on an accuracy of the predicted resource usage predicted by the time series model.

6. The computer-implemented method of claim 1, wherein the resource usage of the plurality of container clusters includes central processing unit usage, memory usage, storage usage, and network usage, and
wherein the operation behavior includes a frequency of usage of the plurality of container clusters and task priorities associated with the plurality of container clusters.

7. The computer-implemented method of claim 1, wherein releasing the one or more resources comprises:
releasing the one or more resources based on a minimal cluster capacity of the container cluster.

8. A computer program product comprising:
one or more computer-readable storage media; and
program instructions stored on the one or more computer readable storage media to perform operations comprising:
determining, using a machine learning model, different groups of container clusters for a plurality of container clusters of a platform, wherein the different groups of container clusters are associated with different levels of resource usage;
determining a particular group of container clusters with a lowest level of resource usage of the different levels of resource usage;
predicting, using a time series model, predicted resource usage of a container cluster of the particular group of container clusters, the time series model being generated based on historical resource usage of the container cluster;
determining whether available resources, of the platform, are sufficient to deploy an application;
releasing one or more resources, of the container cluster, when the available resources are insufficient to deploy the application; and
adding the one or more resources to the available resources to deploy the application.

9. The computer program product of claim 8, wherein the operations further comprise:
determining that an accuracy of the predicted resource usage does not satisfy an accuracy threshold; and
adjusting a window size of the time series based on determining that the accuracy of the predicted resource usage does not satisfy the accuracy threshold.

10. The computer program product of claim 8, wherein determining the different groups of container clusters comprises:
determining the different groups of container clusters based on information regarding resource usage of the plurality of container clusters and a frequency of usage of the plurality of container clusters.

11. The computer program product of claim 8, wherein the operations further comprise:
predicting, using the time series model, resource usage of container clusters of the particular group of container clusters;
determining current resource usage of the container clusters;
determining availability of resources of the container clusters based on the future resource usage and the current resource usage; and
sorting the container clusters based on the availability of resources of the container clusters.

12. The computer program product of claim 11, wherein an availability of resources of the container cluster exceeds an availability of resources of one or more other container clusters of the particular group of container clusters.

13. The computer program product of claim 8, wherein releasing the one or more resources comprises:
releasing the one or more resources based on a minimal cluster capacity of the container cluster.

14. The computer program product of claim 8, wherein releasing the one or more resources comprises:
releasing the one or more resources based on a setting regarding a quantity of resources to be released.

15. The computer program product of claim 8, wherein the different groups of container clusters are determined based on information regarding resource usage of the plurality of container clusters and operation behavior of the plurality of container clusters,
wherein the resource usage of the plurality of container clusters includes central processing unit usage, memory usage, storage usage, and network usage, and
wherein the operation behavior includes a frequency of usage of the plurality of container clusters and task priorities associated with the plurality of container clusters.

16. A computer system comprising:
one or more computer-readable storage media;
a processor set; and
program instructions stored on the one or more computer-readable storage media to cause the processor set to perform operations comprising:
determining, using a machine learning model, different groups of container clusters for a plurality of container clusters, wherein the different groups of container clusters identify different levels of resource usage;
determining a particular group of container clusters with a lowest level of resource usage of the different levels of resource usage;
predicting, using a time series model, resource usage of a container cluster of the particular group of container clusters, the time series model being constructed based on historical resource usage of the container cluster; and
adjusting a number of resources, of the container cluster, to deploy an application on the platform.

17. The computer system of claim 16, wherein obtaining the information regarding the activity comprises:
determining whether an accuracy of the predicted resource usage does not satisfy an accuracy threshold; and
adjusting a window size of the time series based on determining that the accuracy of the predicted resource usage does not satisfy the accuracy threshold.

18. The computer system of claim 16, wherein the operations further comprise:
predicting, using the time series model, resource usage of container clusters of the particular group of container clusters;
determining current resource usage of the container clusters;
determining availability of resources of the container clusters based on the future resource usage and the current resource usage; and
sorting the container clusters based on the availability of resources of the container clusters.

19. The computer system of claim 16, wherein releasing the one or more resources comprises:
releasing the one or more resources based on a setting regarding a quantity of resources to be released.

20. The computer system of claim 16, wherein determining the different groups of container clusters comprises:
determining the different groups of container clusters based on information regarding resource usage of the plurality of container clusters and a frequency of usage of the plurality of container clusters.
